(19) United States
(12) Patent Application Publication
(10) Pub. No.: US 2008/0094201 A1
(43) Pub. Date: Apr. 24, 2008

(54) Ultra-low Power, Optically-Interrogated Tagging and Identification System

(75) Inventors: Joseph A. PARADISO, Medford, MA (US); Gerardo Barroeta PEREZ, San Francisco, CA (US); Mateusz MALINOWSKI, Chambersburg, PA (US)

Correspondence Address: NORMA E HENDERSON;HENDERSON PATENT LAW, 13 JEFFERSON DR, LONDONDERRY, NH, 03053, US

(73) Assignee: MASSACHUSETTS INSTITUTE OF TECHNOLOGY, Cambridge, MA (US)

(21) Appl. No.: 11/874,170

(22) Filed: Oct. 17, 2007

Related U.S. Application Data
(63) Continuation-in-part of application No. 11/522,612, filed on Sep. 18, 2006.
Application No. 11/522,612 is a continuation of application No. 10/255,557, filed on Sep. 26, 2002, now Pat. No. 7,109,865.
(60) Provisional application No. 60/852,496, filed on Oct. 17, 2006.

(51) Int. Cl. G08B 26/00

(52) U.S. Cl. 340/505

(57) ABSTRACT

Identification tags are used to distinguish a unique tagged item from among a plurality of items. Tagged items are searched by scanning the items with an interrogation signal. The tag emits an observable signal when it receives an identification that matches the identification contained in the tag. When an interrogation signal is not present, the tags sleep at a very low power level or are passively unpowered. A quasi-passive wake-up function employs a continuous low power standby mode, comparing a received signal to a predetermined signal and waking up the device when the predetermined signal is received. The tags can talk back to the interrogator, permitting them to respond with an identification code or to be remotely programmable. The tags can be powered by alternative power sources, including by solar cells or photocells capturing ambient light or a signal received from the interrogator.

### RELATED APPLICATIONS

This application claims the benefit of U.S. Provisional Application Ser. No. 60/852,496, filed Oct. 17, 2006, the entire disclosure of which is herein incorporated by reference.

This application is a continuation-in-part of co-pending U.S. patent application Ser. No. 11/522,612, filed Sep. 18, 2006, which is a continuation of U.S. patent application Ser. No. 10/255,557, filed Sep. 26, 2002, now U.S. Pat. No. 7,109,865, the entire disclosures of which are herein incorporated by reference.

### FIELD OF THE TECHNOLOGY

The present invention relates to object identification and location and, in particular, to a system for locating a specific object from among a plurality of objects that have similar appearances.

### BACKGROUND

Radio-Frequency Identification (RFID) has become a well-established technology, with passive ID tags exploiting magnetic, electrostatic, and RF coupling becoming established as common products [Finkenzeller, K. RFID Handbook, New York: John Wiley & Sons, 2003]. Although RFID tags are well on their way to becoming ubiquitous, they have some characteristics that can inhibit their application in certain niches. For example, the presence of closely proximate metal can interfere with antenna performance, and long-range communications at conventional carrier wavelengths typically involve an antenna that can become quite large. In addition, as the unlicensed bands where RFID tags operate become more crowded, the tags can become subject to interference.

Passive optical identification tags are commonplace in the form of barcodes. Although many different barcode protocols have been developed [see, e.g., Palmer, R. C., The Bar Code Book, Helmers Publishing; 3rd edition (Nov. 1, 1995)], they generally take much more time to read than active tags, prohibiting a fast scan across many objects. The read range is also limited for barcodes, e.g., generally well within a meter. Likewise, barcode scanners have to be properly aligned, and barcodes have no capability of working in a bidirectional fashion.

Active optical communication [Otte, R., de Jong, L. P., and van Roermund, A. H. M., Low-Power Wireless Infrared Communications, Dordrecht: Kluwer, 1999] is also commonplace, such as in items like remote controls. These data channels typically run at fairly low rates (e.g., hundreds of bits per second), and the active infrared (IR) receivers that are used require on the order of several milliamps of operating current. This leads to a relatively short tag lifetime. IRDA communication links, common in laptop computers and cell phones, work at higher data rates, but still tend to consume significant current. In actual practice, the few tagging systems using optics in commercial development tend to combine RF and light. For example, the Pharmaseq system [U.S. Pat. No. 6,686,158, Mandecki, W., “Electronically-indexed solid-phase assay for biomolecules,” Feb. 3, 2004] uses a large array of chemical-sensing RF microtransponders, powered by light, for bioassays, and the general-purpose passive MM chip from First Hill Electronics [FEC International, Kuala Lumpur, Malaysia] is programmed via proximate IR and read via RF.

The original FindIT Flashlight project [U.S. Pat. No. 7,109,865; Ma, H. and Paradiso, J. A., “The FindIT Flashlight: Responsive tagging based on optically triggered microprocessor wakeup,” in UbiComp 2002, G. Borriello and L. Holmquist, Eds. Berlin: Springer-Verlag, 2002, 160-167] addresses the problem of short tag life by use of “quasipassive wakeup,” wherein analog signals from the photodiode are conditioned by a passive filter to desensitize the system to ambient light and then are detected by a nanopower comparator, which activates the onboard microcomputer when triggered. Accordingly, as the bulk of the electronics are woken directly from the presence of a modulated optical carrier, the quiescent current of this device is on the order of a half of a microampere, meaning that, for example, a tag using a 48 mA-h, 3V lithium coin cell could operate for over 10 years. Even assuming that the tag is successfully located 25 times per month, the battery would still last for eight years, as driving the onboard LED to indicate a match draws significantly more current.

A recent project from VTT Electronics in Finland [Strommer, E. and Suojanen, M., “Micropower IR Tag—A New Technology for Ad-Hoc Interconnections between Hand-Held Terminals and Smart Objects,” Proc. of the Smart Objects Conference (sOc 2003), Grenoble, France, May 30, 2003], built upon the work with the FindIT Flashlight, is an IR module that can be retrofit into other equipment to provide a wireless interface with low-power wakeup, but it requires a relatively high quiescent current.

### SUMMARY

In one aspect, the present invention is a wireless identification system that employs a communications link between an array of uniquely identifiable tags and an interrogator flashlight. In another aspect, the present invention is an active ID tag. In the preferred embodiment, the interrogator and tags are optically-based. Tagged items are searched by scanning the items with an interrogation signal. The tag emits an observable signal when it receives an identification that matches the identification contained in the tag. When an interrogation signal is not present, the tags sleep at a very low power level or are passively unpowered. A quasi-passive wake-up function employs a continuous low power standby mode, comparing a received signal to a predetermined signal and waking up the device when the received signal is the same as the predetermined signal. In one embodiment, the tags respond back to the interrogator with an identification code or to be remotely programmed. The tags can optionally be powered by alternative power sources, including by solar cells or photocells capturing ambient light or a signal received from the interrogator.

In one aspect, the present invention is an optical identification system comprising an interrogator and a plurality of identification tags. The interrogator transmits optical signals having an encoded identification associated with selected tags and receives information from responding tags. The tags each contain a tag identification uniquely identifying the tag, with each tag being responsive to a differently modulated optical signal whose encoded identification matches the tag identification. Each tag has at least one transducer for imparting an observable signal upon receipt of the optical signal and for communicating information back to the interrogator.

In another aspect, the present invention is an identification system comprising an interrogator and a plurality of identification tags. The interrogator transmits signals having an encoded identification associated with selected tags and receives information from responding tags. The tags each contain a tag identification uniquely identifying the tag, with each tag being responsive to a signal whose encoded identification matches the tag identification. Each tag has at least one transducer for imparting an observable signal upon receipt of the signal and for communicating information back to the interrogator and each tag is maintained in a low-power shutdown mode until the signal is detected.

In a further aspect, the present invention is an optical identification tag comprising a receiver for receiving a unique modulated optical signal encoding a tag identification, a memory for storing the tag identification uniquely identifying the tag, a device for emitting an observable signal in response to the unique modulated optical signal when the received tag identification matches the stored tag identification, and a power source that supplies an operating current for the tag and that derives energy from an ambient condition to which the tag is exposed or a signal received from the interrogator. The power source preferably comprises at least one solar cell or photocell.

In a further aspect, the present invention is an identification tag comprising a receiver for receiving a signal encoding a unique tag identification, a memory for storing the tag identification uniquely identifying the tag, a power source that supplies an operating current for the tag, the power source deriving energy from an ambient condition to which the tag is exposed or a signal received from the interrogator or a signal received from the interrogator, circuitry that causes the tag to operate in a sleep mode when not processing the signal, and a device for emitting an observable signal in response to the signal when the received tag identification matches the stored tag identification. The power source preferably comprises at least one solar cell or photocell.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram of a generic embodiment of an object-locating system in accordance with one aspect of the present invention;

FIG. 2 is a block diagram of a preferred embodiment of an optical tag and interrogator, according to one aspect of the present invention;

FIG. 3 is a circuit diagram of a preferred embodiment of photodiode amplifier/limiter circuitry according to another aspect of the present invention;

FIG. 4 depicts a noisy signal from an amplifier and recovered serial output from a nanopower comparator for an embodiment of a reader at 5 meter range, according to an aspect of the present invention; and

FIG. 5 is graph depicting tag battery life as a function of the number of wakeups and the fraction thereof that illuminate the LED.

### DETAILED DESCRIPTION

In one aspect, the present invention is a wireless identification system that employs an optical communications link between an array of uniquely identifiable smart tags and an interrogator flashlight. In another aspect, the present invention is an optically-coupled active ID tag. Tagged items are searched by scanning the items with an interrogation signal. The tag emits an observable signal when it receives an identification that matches the identification contained in the tag. When an interrogation signal is not present, the tags sleep at a very low power level or are passively unpowered. A quasi-passive wake-up function employs a continuous low power standby mode, comparing a received signal to a predetermined signal and waking up the device when the received signal is the same as the predetermined signal. The tags can talk back to the interrogator, permitting them to respond with an identification code or to be remotely programmed. The tags can be powered by alternative power sources, including by photocells capturing ambient light.

Tags according to the invention typically consume a quiescent current of under 2 microamperes and are woken up directly by the modulated illumination of the interrogator, so they are able to last nearly the shelf life of their battery when experiencing moderate use. Unlike RFID, which requires a large antenna to achieve significant range, the system requires only a small photodiode, which enables very compact tags to be rapidly queried at a range of over 8 meters with a handheld flashlight interrogator. The tags are particularly suited for an asset location scenario, pulsing an onboard LED when their stored ID matches a query broadcast by the interrogator.

The system of the present invention is a descendant of the optical version of the original “FindIT Flashlight” system [U.S. Pat. No. 7,109,865; Ma, H. and Paradiso, J. A., “The FindIT Flashlight: Responsive tagging based on optically triggered microprocessor wakeup,” in UbiComp 2002, G. Borriello and L. Holmquist, Eds. Berlin: Springer-Verlag, 2002, 160-167], which uses a hand-held reader built into a flashlight casing. Although, unlike RFID, an optical line-of-sight is required, the system retains the familiar metaphor of a flashlight, where a user looks for a tagged object by casting the interrogation beam about. A flashlight can be easily adjusted to seek remote tags within a narrow illumination cone, or, by twisting a lens, generate a wider beam that can locate proximate tags more broadly spaced. Narrow interrogation beams are also more appropriate for applications that require a measure of privacy or security (e.g., identify friend-or-foe operations). Such high directivity and simple beam adjustment are not possible with compact RFID readers at conventional frequencies. One of the applications for this system is locating removable storage media that contain specific files. With shrinking form factors limiting available space for scrawling titles at the edges of media cases, a solution was created by which an optical interrogator could be programmed with the ID of the volume upon which a file was written. This volume can then be located on a shelf by scanning the flashlight interrogator across and looking for a tag responding with a flashing LED to indicate a match.

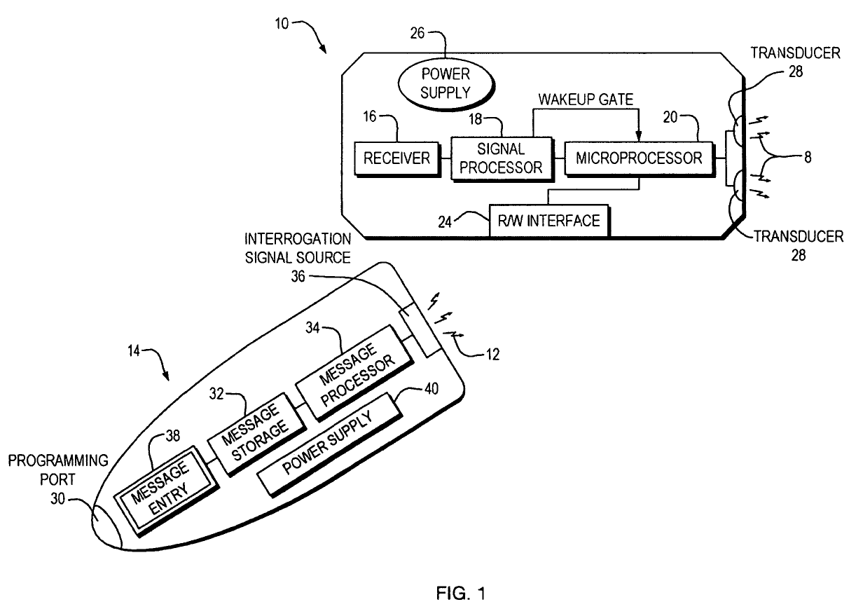

FIG. 1 provides a general overview of an embodiment of a generic object-locating system according to the present invention, whereby a single item can be quickly and precisely located from among a plurality of similar items. A searcher can locate the specific item sought by identifying the source of observable signal 8 emitted by identification tag 10. In one embodiment, identification tag 10 emits observable signal 8 when it receives unique interrogation signal 12. The search protocol provided by the system allows an area to be rapidly scanned without the need to individually inspect each item.

Each identification tag 10 is associated with a unique object. In one embodiment, identification tag 10 is affixed to or otherwise associated with the object. In another embodiment, tag 10 is affixed to or otherwise associated with an item in close proximity to the object, such as, but not limited to, a cartridge, a storage container, a physical location, or an article of clothing. The system also includes transmitter 14 that transmits interrogation signal 12 in order to locate the object being sought. Interrogation signal 12 may be any signal, such as, but not limited to, an RF signal, an optical signal, or a microwave signal, so long as the signal can provide wireless transmission of an object identification. The object identification is information that uniquely identifies one of the tagged items.

In one embodiment, tag 10 includes receiver 16, signal processor 18, microprocessor 20, read/write interface 24, power supply 26, and one or more transducers 28. Receiver 16 may comprise any device such as, but not limited to, an antenna, a photodetector, or a rectenna, provided it is capable of wireless reception of interrogation signal 12. The received signal is processed by signal processor 18, which may comprise one or more digital and/or analog electronic components. For example, signal processor 18 may provide filtering and signal conditioning to facilitate comparison of the object identification contained in interrogation signal 12 with the tag identification contained in a memory of microprocessor 20. Alternatively, the tag identification may be stored in the media itself. For example, the tag identification may be written onto a protected section of an information storage disk, such as, but not limited to, a CD or DVD.

In one version, the tag identification is stored within tag 10 at the time it is manufactured. In another version, the tag identification is written to microprocessor 20 at a later point in time such as, for example, when the system is configured for a specific application. In one embodiment, tag 10 includes read/write interface 24 that facilitates the writing of the tag identification to tag 10 and subsequent alteration thereof. In another embodiment, read/write interface 24 allows the tag identification to be read by another device. It should be understood, however, that read/write interface 24 is not required, such as where the tag identification is provided at the time of manufacture or system initialization. In either case, tag 10 may include an external surface where the stored tag identification is also reproduced visibly for easy reference. The ability to read and write the tag identification to or from memory located in tag 10 is particularly advantageous when tag 10 is associated with an object of electronic storage media. For example, at the time information is stored in a unique media object, the object identification of the media can be automatically associated with tag 10 via read/write interface 24, thereby identifying the media item where the information is stored. In one version of this embodiment, read/write interface 24 facilitates physical connection to, for example, but not limited to, the serial port of a personal computer. Alternatively, interface 24 may utilize wireless, non-contact communication. For example, interface 24 may be an optical signal path, an RF signal path, or any other suitable means of wireless-type communication.

Regardless of whether read/write interface 24 is used, each unique object is associated with a unique tag identification. This association creates an object identification that may later be used to identify the object from among a plurality of similar items. Additionally, to facilitate future searches, it is advantageous to record an object-identification/tag-identification association in a manner that allows for its later retrieval. In one embodiment, the association is recorded in a computer database. In a version of this embodiment, the association is automatically recorded when information is stored in an object of electronic storage media.

In one embodiment, tag 10 is also equipped with power supply 26 that supplies power to the tag's electronic components. Power supply 26 may be any suitable type of power supply known in the art, so long as it is capable of supplying sufficient power to the tag electronics when required and is sufficiently small size to fit on the tag.

In one embodiment, power supply 26 is a battery. In an implementation of this embodiment, power supply 26 is a lithium coin cell. In one embodiment, tag 10 operates in a substantially passive mode despite the fact that tag 10 includes power supply 26. In particular, identification tag 10 operates in a low-power shutdown mode until interrogation signal 12 is detected. In one embodiment, substantially passive operation is achieved, in part, because tag 10 does not include a linear amplifier. Instead, the tag includes a filter to isolate the carrier frequency of interrogation, and a very low power comparator to detect the frequency and wake up microprocessor 20. Tag 10 desirably draws less than 500 nanoamps when not processing interrogation signal 12, preferably less than 100-300 nanoamps.

In one embodiment, tag 10 is comprised of a single integrated circuit. However, tag 10 need not be a single unit and it is described in this manner only for reference. Thus, various of the identified system elements may be moved outside tag 10 provided that the functional objectives are achieved. For example, transducers 28 may be located in a storage rack adjacent the tagged item.

In one embodiment, transmitter 14 of FIG. 1 includes programming port 30, message storage device 32, message processor 34, interrogation signal source 36, message entry device 38, and power supply 40. Message storage device 32 stores one or more object identification messages. Additionally, to ease the retrieval of object identification messages, message storage device 32 (or an external computer in communication with message storage device 32) may also store one or more item/message associations in a database. These associations allow a user to simply select the item to be located, and the database then selects the corresponding object identification message. In one embodiment, transmitter 14 includes a separate memory for storing these item/message associations. Message storage device 32, which may be, but is not limited to, a microcontroller incorporated in a circuit card, supplies the object identification message to message processor 34, which embeds this in an output signal in a detectable fashion such as, but not limited to, by modulating the signal. For example, the object identification message may be embedded in either an AM or a FM signal. With either signal type, the signal includes a carrier frequency with a signal characteristic altered in a manner that encodes the message in the signal. Additionally, regardless of the modulation scheme employed, the message is encoded such that when interrogation signal 12 is demodulated by tag 10, the message includes the object identification. In a version of the AM embodiment, message processor 34 comprises an amplitude-modulating driver, e.g., a MOSFET switch, which acts on the message received from message storage device 32.

Interrogation signal source 36 receives the signal from message processor 34 and transmits it in a format that is compatible with tag receiver 16, for example, as an optical or RF signal. To encode the message, message processor 34 causes interrogation signal source 36 to alter the output intensity or frequency of interrogation signal 12. For example, in the optical embodiment, the intensity of the resulting interrogation signal 12 is altered in response to the modulated signal. In one version of this embodiment, message processor 34 provides an amplitude-modulated 2 kHz signal that is converted to an optical signal by interrogation signal source 36. Interrogation signal source 36 may be a laser diode. In one version, the laser diode is a 5 milliwatt red diode laser similar to laser diodes employed in laser pointers. In another version of this embodiment, interrogation signal source 36 is an array of bright LEDs. Interrogation signal source 36 may include a lens, such as, but not limited to, a defocusing lens. The ability to defocus optical interrogation signal 12 is advantageous because it improves the system's safety and broadens the search area. Alternatively, transmitter 14 may include an adjustable lens capable of being adjusted to change the area that is reached by interrogation signal 12. The range of transmitter 14 is desirably at least three meters.

Optical interrogation is advantageous generally, because it provides visual confirmation of the area that is being searched at any moment. Thus, optical interrogation increases the speed and efficiency of the search. Additionally, optical interrogation is compatible with common experience, such as scanning a darkened room with a flashlight, so its operation is natural and familiar.

Programming port 30 and message entry device 38 each provide independent, or alternative, means of entering one or more object identifications into transmitter 14. In one version, programming port 30 is a USB port that facilitates the serial transmission of information from a computer or other electronic storage device to transmitter 14. Alternatively, in another version, programming port 30 is a receiver for receiving object identification information that is transmitted to transmitter 14 via a wireless LAN (e.g., IEEE standard 802.11). In this way, a database of objects and identifiers associated therewith may be stored on an external computer. When the user selects an item of interest, the database supplies the corresponding identifier to message entry device 38 via programming port 30. The user therefore need not maintain any awareness of object identifiers, simply selecting the desired item. The database may alternatively be included in memory located within tag 10, and the item selection may be entered directly into tag 10 via programming port 30. Alternatively, the user may identify the desired item directly, using then message entry device 38. This may be, for example, a keypad or a writing pad integral to a personal digital assistant in which transmitter 12 is implemented. In still another version, message entry device 38 includes one or more switches.

The system achieves an energy efficient interrogation scheme because transmitter 14 can be configured to consume a minimal amount of power. For example, in one embodiment involving optical signals the total power drawn by transmitter 14 is less than or equal to 60 milliamps. As a result, transmitter 14 can be integrated into wireless handheld devices such as, but not limited to, a personal digital assistant or cellular phone.

Signal processor 18 of tag 10 includes a circuit such as, but not limited to, a passive filter, that isolates particular characteristics of the interrogation signal such as, but not limited to, its carrier frequency, as detected at receiver 16, from background signals. The signal processor is designed to operate at very low power. When the interrogation signal is detected, a logic gate is asserted, which wakes up microprocessor 20. Receiver 16 and signal processor 18 of tag 10 cooperate to condition the object identification code in the received signal such as, but not limited to, by demodulation or discrimination. Microprocessor 20 then compares the stored tag identification with the object identification received with interrogation signal 12. Upon detection of a match, microprocessor 20 causes transducer 28 to emit observable signal 8. Observable signal 8 may be audible, visible, or both. In one version, transducer 28 comprises one or more light emitting diodes (LEDs). In a further version, transducer 28 comprises a piezoelectric buzzer. A plurality of transducers 28 may be used to increase the amount of information conveyed by tag 10 upon interrogation. For example, one observable signal 8 may be emitted when tag 10 receives an object identification that matches the tag identification and a different observable signal 8 may be emitted when tag 10 receives an object identification that does not match the tag identification.

In an alternate embodiment, tag 10 may be employed to block an otherwise observable signal from view until the object identification matching the identification contained in tag 10 is received. Upon receipt of the matching identification, tag 10 allows the signal to be observed. In this case, observable signal 8 may be emitted from a source external to tag 10. For example, in one embodiment, tag 10 may include a window that under ambient conditions is opaque, and therefore blocks a light source located behind tag 10. However, the window becomes transparent when the object identification associated with the tagged item is received, thereby allowing observable signal 8 to be seen. In one version of this embodiment, the window is a liquid crystal that can be toggled between an opaque state and a transparent state. This version is advantageous because the power consumption of tag 10 is reduced as a result of the low power requirements of the liquid crystal.

The present invention improves the original design in several respects, including addition of a micropower amplifier and an improved flashlight interrogator to more than double the sensitive range, the addition of a talkback channel for bidirectional communication, and alternative power sources for the tag. The present invention has several advantages, including that the tags are typically able to operate on the same battery for more than 5 years. This is important when hundreds of tags are deployed, since it would be cumbersome to change the batteries on the tags every few months. Operation range from the Flashlight to the tag is preferably at least 3 meters, and the system is fast enough to pick up the signal even if the flashlight beam is quickly swept past. Because many tags must be scanned rapidly, this is facilitated by being able to quickly move the flashlight when the user is standing a few meters away. The data rate preferably supports sending a 4-byte binary message sufficiently fast. The typical tags measure roughly 0.5″ per side, which is important because the tags in many applications must be adhered where there is not much free space in which to place them.

In one currently implemented embodiment, the system receives the optical signal with a photodiode of only 1.5 mm diameter, so the tags can be very small, limited mainly by the size of their associated battery. In this embodiment, a 16 mm diameter CR1632 coin cell is employed, but clearly any of the many other suitable sizes and types of batteries are suitable for use in the invention. The tags are woken up from a deep sleep directly by the interrogator's modulated light beam. The very low standby current of these tags (under 2 μA) can enable their longevity to surpass 7 years, approaching the decade-long battery shelf life.

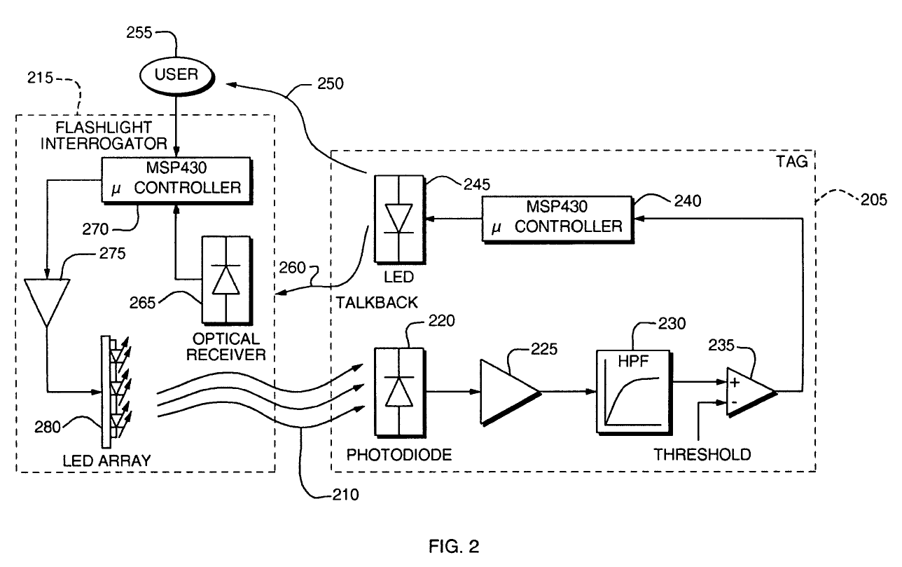

FIG. 2 is a block diagram of a preferred embodiment of an optical tag and interrogator according to the present invention. In FIG. 2, tag 205 receives signal 210 from flashlight interrogator 215 at photodiode 220. analog signals from the photodiode are conditioned by amplifier/limiter 225 and passive filter (HPF) 230 to desensitize the system to ambient light and then are detected by a nanopower comparator 235, which activates the onboard tag microcontroller 240 when triggered. Tag microcontroller 240 causes LED 245 to provide visible indicator 250 to user 255 and, if appropriate and present, optional talkback signal 260 to optical receiver 265 of interrogator 215. Optical receiver 265 provides the received signal to interrogator microcontroller 270 which causes driver 275 to activate LED array 280.

In a prototype designs implementation, a modulated defocused laser beam was used in the flashlight to interrogate the tags, initially from a 5 mW red laser diode and later from a 35 mW IR laser diode. The light coming from the laser then induces a current in a photodiode on the tag, which in turn wakes up a PIC12LC509A microcontroller from its low power shutdown mode. To avoid the effects of ambient light and low-frequency illumination, the signal from the photodiode is conditioned by a passive RC high-pass filter, and then discriminated by a LTC1540 nanopower comparator with internal voltage reference. This process generates a clean digital gate upon sufficient illumination and eliminates the need for a linear amplifier, which would have consumed much more power, something not desirable when using batteries. This produces an interrupt to wake the processor, a process that is termed “quasi-passive wakeup” because of the lack of an amplifier stage and the extremely low quiescent current (circa 500 nA).

Once the microcontroller emerges from its sleep mode, the encoded message is compared against a hard coded identification number, specific to each tag. If the code matches, a green LED blinks for a short interval to indicate that the desired tag had been found; otherwise a red LED is lit. The red LED may optionally be eliminated to reduce power consumption, and it will be clear to a person having ordinary skill in the art that any other colors of LEDs, or other light-emitting devices, as well as other means of transmitting an observable signal, may be advantageously employed in the tag of the invention. In a prototype system, the maximum read range was approximately 3 m, however the 2 kHz modulation scheme needed roughly 26 ms to transmit a 16-bit code. Additionally, even though the laser beam was defocused to increase the light spot's size, hence loosen requirements on aiming the sensor, the spot diameter was still only on the order of only 2 cm at 3 meters, which made pointing difficult at longer ranges. In one embodiment, an onboard IR LED is used to send data a meter away when the interrogator illumination is off. In another embodiment, an onboard green indicator LED is used for proximate operation

In a second embodiment, the original microcontroller was replaced by a Texas Instruments MSP430F122 with a 100 nA typical draw in the deepest sleep mode and an internal RC oscillator, reducing power consumption and physical footprint. The photodiode was also replaced with a smaller, faster device (a Sharp PD100MCOMP), which was back-biased at 3V to improve sensitivity. The comparator stayed the same, however components were changed to accommodate the increased signal speed (from 2 kHz to 10 kHz), which allowed rapid identification even when the light was quickly passed across a tag. This embodiment also employs a high-intensity LED panel containing 20 red LEDs, arranged in four rows of 5 LEDs each. In normal operation, the panel operates at 12-13V and consumes between 350-450 mA. Since common silicon photodetectors tend to respond more strongly to infrared light, most of the LEDs are near-IR, emitting at 845 nm, which is well matched to the peak sensitivity of the PD100M. The last LED on each one of the four columns is a visible ultrabright red LED. This gives the user visual feedback, allowing them to easily point the light beam, plus it helps in debugging, making any primary failures in the interrogator obvious.

To increase the operating range and work with broad illumination beams of lower intensity, a Texas Instruments OPA349 operational amplifier was added to the signal chain to provide gain before the comparator. Although it dominates the quiescent power budget of the tag, this amplifier consumes a maximum steady-state current of circa 2 μA, which doesn't significantly impact battery life for the coin cell that was chosen. As the output current from the photodiode can vary from picoamperes in extremely dim light to hundreds of microamperes in bright illumination and the light intensity coming from the Flashlight could vary widely depending on the distance at which it was placed from the tag, linear photodiode amplifiers exhibited problems in balancing saturation vs. sensitivity. Hence, a robust amplifying scheme that would cleanly condition a signal with flashlight-to-tag distances ranging from zero to three meters was needed. Accordingly, a logarithmic amplifier/limiter that would adjust its gain depending on the light received from the Flashlight was employed.

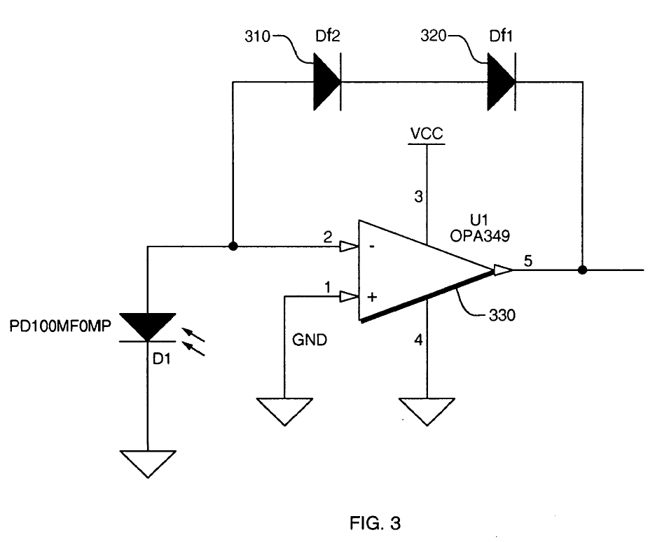

FIG. 3 depicts a preferred embodiment of photodiode amplifier/limiter circuitry according to one aspect of the present invention. To mitigate the effect of junction capacitance and raise the compression threshold, two transdiodes 310, 320 are placed in series. There are two different operating conditions for this circuit. When the flashlight is far from the tag, the photodiode generates a very weak signal and a large gain is desirable. In this case, the low current coming from the photodiode is not sufficient to generate a voltage high enough to turn on feedback diodes 310, 320, so OpAmp 330 and parasitic characteristics determine a maximum gain. When the flashlight approaches the tag and diodes 310, 320 start to turn on, the gain drops accordingly, hence the output of the amplifier is clamped at a dual diode drop of roughly 1.2 volts. In this manner, the amplifier is not allowed to saturate, which would degrade the signal quality. This amplifier configuration greatly extends the operating range of the system, as it is now able to robustly work at up to 8 meters, depending on ambient lighting conditions.

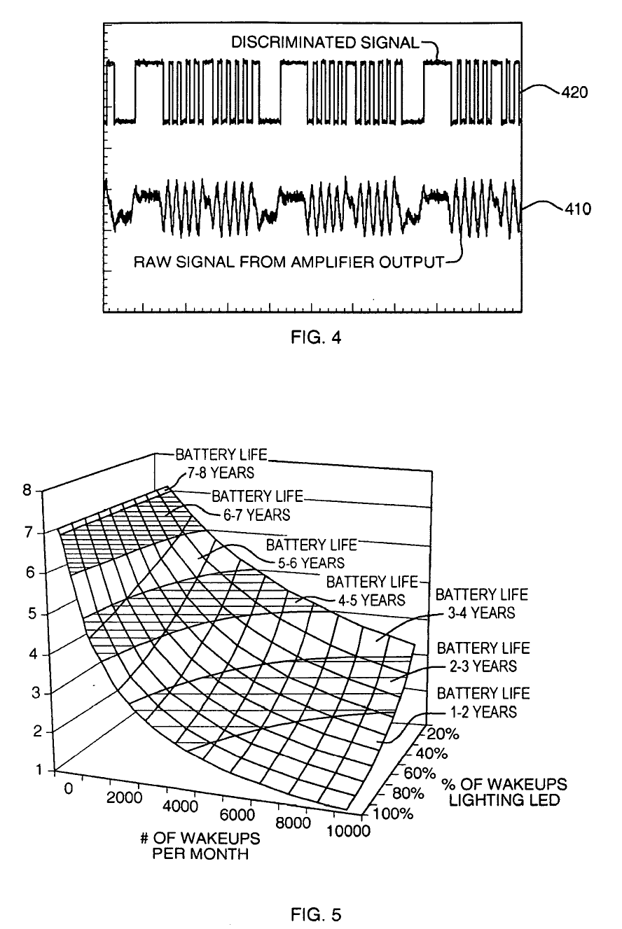

The amplified signals must be discriminated by the nanopower comparator before being sent to the microcomputer. FIG. 4 depicts a noisy signal 410 from the amplifier and the recovered serial output 420 from the nanopower comparator for an embodiment of a flashlight reader at 5 meter range. As seen in FIG. 4, the comparator is effective at cleaning up signals received at high range. Since it never saturates from background lighting, the amplifier is DC coupled. In a preferred embodiment, the comparator is AC-coupled via a first-order highpass filter that rolls off the response to ambient light and discriminates with respect to the average voltage level, as described in Malinowski, M., “Optical Wakeup of Micropower Tags for Object Location and Identification,” AUP Undergraduate Thesis, MIT EECS Dept. and Media Lab, May 20, 2004. The digital circuitry is preferably exclusively composed of the microcontroller, in the embodiment described is an MSP430F122HBR in a 32-pin QFN package, ideal for an extremely small layout and ultra-low power consumption. The internal Digitally-Controlled Oscillator is used in lieu of an external crystal to keep circuitry and power consumption to a minimum. Also, the internal DCO only takes 6 μs to start when waking up from the low-power mode instead of milliseconds for crystals. A Texas Instruments TPS3836 voltage supervisor was also included in this embodiment, in order to increase supply line robustness. This supervisor consumes less than half a μA, so the impact it has on power consumption is nearly negligible. A Molex flat cable connector was included for re-programming the microcontroller.

In this embodiment, the microcontroller is configured to run at 1.3 MHz and uses 350 μA in active mode and 200 nA when waiting for a signal. When receiving a UART start-edge condition from a state change in the discriminated photodiode signal, it wakes up from low-power mode 4 (the deepest sleep mode) and receives the code. Once the microcomputer processes the code, as detailed below, it decides whether or not to answer based on the instruction or the code received. If “find mode” is commanded, the tag just compares the code received to its stored ID, and gives a visual feedback by flashing its onboard green LED for 1 second if there is a match.

In one implementation, the circuit card measures 12 mm on each side; hence the package is dominated by the attached battery. For this application a 3V CR1632 Lithium coin cell battery was chosen, which provides 125 mA-h. As the circuit has been measured to consume 1.8 μA in standby mode, the tags can work for more than 7 years on a single battery. In reality, this lifetime will degrade depending on the quality of the battery and the amount of activation that the tags actually encounter (they take 0.35 mA when the processor runs and 1.25 mA when flashing the LED).

If the tag is interrogated several times per day, there is still ample charge to surpass the 5-years-of-life mark, as illustrated by the graph depicted in FIG. 5. The tag lifetime can be further improved by paralleling two batteries in order to increase capacity. In lots of 1000, these tags can currently be manufactured for less than US $8, with the price dropping quickly for larger quantities.

A prototype reader/interrogator according to one aspect of the present invention is based on a cannibalized handheld flashlight, with a keypad added to program the transmit code. Tags located within a few meters of the flashlight can be detected within a roughly 90° cone—at 8 meters, this narrows to approximately 45°. The current flashlight runs off two 7.4 V, 2.15 A-h Lithium Ion rechargeable batteries, each in a 18×65 mm cylindrical package.

Because the amplified photodiode signal is AC coupled to the comparator through the high-pass filter, the encoding scheme should be zero-balanced; i.e., there should be the same number of 0 bits as 1 bits. This is implemented via a biphasic Manchester code [Mills, A., “Manchester encoding using RS232 for Microchip PIC RF applications,” Web publication, January 2002], where, for every bit of information, the Flashlight transmits two bits (“10” for a logic “1” and “01” for a logic “0”). This effectively halves the data rate available for transmission but still provides 5 Kbps, enough to transmit a 4-byte code in a few milliseconds, which is adequate for operation with fast beam sweeps.

In order to differentiate rotationally equivalent codes, the decoding program is preferably synchronized with the beginning of the transmission frame. This is usually done with a unique sequence that does not code for any information and can serve to demark the transmitted command or ID query. Upon recognizing it, the decoding program initializes and begins decoding subsequent data. An additional characteristic of Manchester encoding is that the sequences “00” and “11” are illegal, and do not code for any information. This allows the byte “00 00 11 11” to be used as a unique sequence that bounds the transmission frame and initiates decoding. This Manchester-encoded data is put into an RS-232 serial-communication wrapper, which allows the processor and tag to send and receive the data directly via the on-chip UART module. This added layer of abstraction increases usability, robustness (the serial port module on MSP430-series processors implements error checking, for example), and access to advanced features, such as “receive-start edge detection,” which stores an incoming byte long enough for the processor to wake up from a low-power state and decode it. Upon receiving a character, the tag's microcontroller verifies that it is the frame boundary. If so, it decodes the following characters in a manner inverse to the procedure described above. Full wakeup of the MSP430 only happens after its UART produces an interrupt upon receiving a valid byte of serial data. Although false transitions can occasionally occur with rapid bright illumination shifts (e.g., room lights going quickly on or off), false wakeups are extremely rare.

It will be clear to a person having ordinary skill in the art that the present invention can be similarly implemented to wake up upon receipt of other kinds of stimuli besides RF or optical signals. The system can, for example but not limited to, wake up on receipt of other types of light, vibration, or sound. The wakeup signal can also be broadcast over a large area, such as a warehouse, in order to, for example, “light up” all packages of a certain type.

The present invention further contemplates multiple techniques that permit the tags to talk back to the interrogator and/or to store information. This is useful for many purposes including, but not limited to, inventory control or efficient deployment. In one embodiment, the system is operated by pointing the flashlight at a unique tag and commanding it to respond with its ID code and/or by enabling codes to be programmed on the fly. The tag responds by sending back information optically, such as, but not limited to, by modulating its LED, possibly on a phase-locked carrier, by RF, by sound, or by any other means known in the art. The threshold for receiving the data can optionally be adaptive, in order to accommodate the requirements of more or less noisy environments.

The talkback link allows the tags to communicate back to the reader. This can be implemented in any of the many suitable ways known in the art. Prototypes have heretofore been implemented in two ways. One embodiment uses an additional IR LED onboard the tag to send Amplitude Shift Keyed (ASK) data at a standard frequency of 38 KHz, which allowed us to use an integrated PNA4613 IR receiver module on the Flashlight. This system supports talkback communication at up to a meter of range and enabled the tags to respond at 1200 bps, which is sufficient to send a test message consisting of a framing byte and six data bytes within 60 ms. Another embodiment exploits the visible green LED. By modulating it with data at 10 kHz using the Manchester scheme described above, it is possible to talk back to the flashlight over several cm of range. As the primary uses envisioned for the optional talkback feature involve querying a particular tag and having it send its ID code in response to a blanket command, proximate operation is frequently sufficient and appropriate. Both of these embodiements send data back from the tag in the interval between flashlight data packets, where the flashlight LEDs are off. Another technique tightly phase-locks the talkback LED on the tags to the interrogator's modulation. Although the data rate is somewhat lower, the signal-to-noise, and hence range, can be significantly larger.

A compact (1.6 cm diameter) active micropower optical tagging system has been demonstrated that performs at long range (e.g., 8 meters), and has been implemented with two different modes of talkback from tag-to-reader that work at shorter range. As the tags take 1.8 μA of quiescent current when waiting for activation, 0.35 μA when briefly activated to check their code, and 1.25 mA when flashing their LED, they should last nearly the shelf life of the battery, even with over a dozen wakeups per day. The current system sends 3-byte messages from the reader. As the first byte is reserved for framing, an 8-bit ID space can be addressed with Manchester Coding. The 5-kbs data rate is sufficiently fast to add additional bytes of ID if needed and maintain rapid enough operation to allow a quick flashlight sweep to detect any matching tags. The tags behaved well, with the passive filter and comparator effectively eliminating stray triggering from ambient light and the intrinsic rolloff of the amplifier's gain at high frequency making the system insensitive to modulation from fluorescent lighting.

It will be clear to a person having ordinary skill in the art that the tags may be totally or partially powered with things other than the battery. This includes solar cells that can harvest ambient power continuously or are powered by light beamed from an interrogator beam. In one embodiment, tags according to the present invention are powerable from ambient illumination sources. The tag's current is sufficiently low to enable a 1-in² solar cell to provide sufficient power to run the tag after integrating ambient light over the course of a day, eliminating the need for a battery. This also includes other kinds of power sources, including, but not limited to, vibration, sound, light, vibration using a piezo electric system, airflow running a small generator, heat flow using a peltier device, charging a capacitor when the system is on, harvesting RF and EM, magnets, springs, and other mechanical methods, an escapement such as in watches which use movement, and changes in barometric pressure with an escapement.

Although the signal-driven wakeup approach minimizes average current, it is particularly desirable to employ passive operation, where solar cells can be used to deliver all or part of the power needed to operate the tag. Two modes are particularly relevant, when running the microprocessor to check the received code and when flashing the visible LED. As the interrogation beam intensity has been measured at 5 μW/cm² 1 meter from the interrogator (and drops quadratically with distance), it is not sufficiently powerful to drive the tag on its own. It has been shown that a 6.5-cm² (1-in²) polycrystalline solar cell can continuously power a flashing tag off a 20 W halogen bulb at 50 cm, implying a very bright interrogator. Power can also be drawn from ambient illumination, as standard solar cells are known to produce 10-100 μW/cm² in a typically illuminated office [Paradiso, J. A. and Starner, T., “Energy Scavenging for Mobile and Wireless Electronics,” IEEE Pervasive Computing, Vol. 4, No. 1, February 2005, pp. 18-27]. Accordingly, by integrating charge on such a 6.5-cm cell from ambient light, the tags can attain 6-60% duty cycle with LED off and up to 2-20% when flashing. This yields at least 90 minutes of operation per 24-hr day without LED or over 30 minutes with LED, which should be ample, especially as the tags are powered for only a second with the LED and only very briefly when no match is found and the LED stays off.

Alternative flashlight designs include more convenient form factors, adjustable lenses, and direct USB or wireless connectivity to enable network dialog, plus a new LED panel that integrates 99 ultra-high performance LED's into a single module, potentially enabling significantly higher range. The tags can have wide or narrow beam selectivity.

The present invention is particularly useful for solving a specific problem encountered by vast blade server farms. Whenever a server fails or becomes infected with a virus, although the server's ID is known, it takes a considerable amount of time to physically locate the specific malfunctioning server in the vast racks of hardware. Especially in the case of a virus infection, the server must be quickly removed or deactivated before the virus has a chance to spread. Because of the proximate metal and limited area available, RFID solutions aren't practical. With the optical tagging system, an attendant can quickly locate it using the Flashlight, sweeping the beam past optical tags fixed to the front panel of each blade server. Other particularly good application areas include, but are not limited to, the areas of sensor nets and healthcare.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention.

What is claimed is:

1. An identification system, the system comprising:
an interrogator for transmitting at least one optical signal comprising an encoded identification associated with a selected tag, wherein each tag responds to a differently modulated optical signal, and for receiving information from a responding tag;
a plurality of tags each containing a tag identification uniquely identifying the tag, each tag being responsive to a modulated optical signal whose encoded identification matches the tag identification; and
associated with each of the tags, at least one transducer for imparting an observable signal upon response of the tag to the optical signal and for communicating information back to the interrogator.

2. The identification system of claim 1, wherein the interrogator is integrated within a wireless handheld device.

3. The identification system of claim 1, wherein at least one transducer is a light-emitting diode.

4. The identification system of claim 1, wherein each tag further comprises a power source that supplies an operating current for the tag, the power source deriving energy from an ambient condition to which the tag is exposed or from a signal received from the interrogator.

5. The identification system of claim 4, wherein the power source comprises at least one solar cell or photocell.

6. An identification system, the system comprising:
an interrogator for transmitting at least one signal comprising an encoded identification associated with a selected tag and for receiving information from a responding tag;
a plurality of tags each containing a tag identification uniquely identifying the tag, each tag being responsive to a signal whose encoded identification matches the tag identification and wherein the tags are maintained in a low-power shutdown mode until the signal is detected; and
associated with each of the tags, a transducer for imparting an observable signal upon response of the tag to the signal and for communicating information back to the interrogator.

7. The identification system of claim 6, wherein the interrogator is integrated within a wireless handheld device.

8. The identification system of claim 6, wherein at least one transducer is a light-emitting diode.

9. The identification system of claim 6, wherein the tag comprises a power source that supplies an operating current for the tag, the power source deriving energy from an ambient condition to which the tag is exposed or from a signal received from the interrogator.

10. The identification system of claim 9, wherein the power source comprises at least one solar cell or photocell.

11. The identification system of claim 6, wherein the tag operates in a sleep mode when not processing the signal.

12. The identification system of claim 11, wherein the tag comprises a power source that supplies an operating current for the tag, the power source deriving energy from an ambient condition to which the tag is exposed.

13. The identification system of claim 12, wherein the power source comprises at least one solar cell or photocell.

14. An identification tag, the tag comprising:
a receiver for receiving a unique modulated optical signal encoding a tag identification;
a memory for storing the tag identification uniquely identifying the tag;
a device for emitting an observable signal in response to the unique modulated optical signal when the received tag identification matches the stored tag identification; and
a power source that supplies an operating current for the tag, the power source deriving energy from an ambient condition to which the tag is exposed or from a signal received from an interrogator.

15. The tag of claim 14, wherein the power source comprises at least one solar cell.

16. The tag of claim 14, wherein the power source comprises at least one photocell.

17. The tag of claim 14, wherein the tag is maintained in a low-power shutdown mode until the optical signal is detected.

18. An identification tag, the tag comprising:
a receiver for receiving a signal encoding a unique tag identification;
a memory for storing the tag identification uniquely identifying the tag;
a power source that supplies an operating current for the tag, the power source deriving energy from an ambient condition to which the tag is exposed or from a signal received from an interrogator;
circuitry that causes the tag to operate in a sleep mode when not processing the signal; and
a device for emitting an observable signal in response to the signal when the received tag identification matches the stored tag identification.

19. The tag of claim 18, wherein the power source comprises at least one solar cell.

20. The tag of claim 18, wherein the power source comprises at least one photocell.
